(19) United States
(12) Patent Application Publication
(10) Pub. No.: US 2009/0033650 A1
(43) Pub. Date: Feb. 5, 2009

(54) VIDEO PROCESSING METHOD, VIDEO DISPLAY DEVICE AND ITS TIMING CONTROLLER

(75) Inventor: Hiroshi TAKEDA, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD., Kawasaki (JP)

(21) Appl. No.: 12/181,547

(22) Filed: Jul. 29, 2008

(30) Foreign Application Priority Data
Jul. 30, 2007 (JP) 2007-197575

(51) Int. Cl. G09G 5/00

(52) U.S. Cl. 345/214

(57) ABSTRACT

Video processing method, a video display device and its timing controller can support video signals having different types of resolutions from ones set in advance without a special circuit identifying the resolution. Timing controller of video display device generates a first horizontal reference signal (HRST_start) indicating start of an active period of a data enable signal and a second horizontal reference signal (HRST_end) indicating end of the active period from an input video signal. Next, timing controller generates control signals (HSP, STB, POL, VCK, and VOE) based on the number of clocks from the rise of the first and second horizontal reference signals (HRST_start and HRST_end) and on signal generation timing values (α, A to D) predetermined for each control signal supplied to drivers.

### REFERENCE TO RELATED APPLICATION

This application is based upon and claims the benefit of the priority of Japanese patent application No. 2007-197575 filed on Jul. 30, 2007, the disclosure of which is incorporated herein in its entirety by reference thereto.

### TECHNICAL FIELD

The present invention relates to a video processing method, a video display device and its timing controller, and particularly to a video processing method, a video display device and its timing controller that supports any resolution.

### BACKGROUND

In recent years, as the number of the video display standards increases, video display devices that support not only normal display standards, but also any resolution are in demand. Timing controllers that generate control signals necessary for displaying video on the video display devices are generally required to support multiple display resolution standards such as VGA (Video Graphics Array) and XGA (Extended Graphics Array). A method having a microcomputer determine the resolution of an input video signal in order to support various display resolution standards is known.

For instance, in order to support any resolution, a video signal resolution converting apparatus that identifies the resolution of an input video signal and converts the pixel density of the input video signal so as to form a video signal having a resolution that matches the display device is proposed in Patent Document 1.

Patent Document 1 discloses a method in which, for a digital video signal having a data enable (DE) signal and a dot clock (DCLK) signal, the number of clocks of the DCLK signal generated during an active period of the DE signal is counted and the resolution of the input video image is identified based on the thus counted number of clocks. Further, the same document also discloses a method in which the number of pulses of the DE signal generated during one vertical synchronization period is counted and the resolution of the input video signal is identified based on the number of pulses.

Based on the resolution information obtained using these resolution identifying methods, control signals supplied to the drivers, such as a source driver start pulse (HSP), a data latch pulse (STB), a polarity inversion signal (POL), a gate driver start pulse (VSP), a gate driver shift clock (VCK), and a gate driver output enable signal (VOE) for the input video data, are generated, and as a result, video can be displayed at the resolution that matches the display device.

[Patent Document 1]

Japanese Patent Kokai Publication No. JP-P2001-142452A (corresponds to U.S. Pat. No. 6,577,322B1)

### SUMMARY OF THE DISCLOSURE

The following analysis is given by the present invention.

The methods of Patent Document 1, however, have problems because of their resolution identifying circuit. The first problem is that the maximum resolution is restricted by the upper limit of the counter used in the resolution identifying circuit. The second problem is that the types of the identifiable resolutions are limited, depending on the kind of the comparator used to compare and identify the resolution. As a result, resolutions not taken into consideration at the time of designing cannot be supported.

The present invention has been devised to solve the problems described above, and it is an object to provide a video processing method, a video display device and its timing controller capable of supporting video signals having different types of resolutions from ones set in advance.

According to a first aspect of the present invention, there is provided a video processing method. The method comprises: having a timing controller of a video display device generate a first horizontal reference signal indicating the start of an active period of a data enable signal and a second horizontal reference signal indicating the end of the active period from an input video signal; and having the timing controller of the video display device generate control signals based on the number of clocks from the rise of the first and second horizontal reference signals and on signal generation timing value determined for each of the control signals supplied to drivers.

According to a second aspect of the present invention, there is provided a timing controller of a video display device. The timing controller comprises: a horizontal reference signal generating circuit that generates a first horizontal reference signal indicating the start of an active period of a data enable signal and a second horizontal reference signal indicating the end of the active period from an input video signal, and a control signal generating circuit that generates control signals based on the number of clocks from the rise of the first and second horizontal reference signals and on signal generation timing value determined for each of the control signals supplied to drivers.

According to a third aspect of the present invention, there is provided a video display device comprising the timing controller described above.

The meritorious effects of the present invention are summarized as follows.

In the present invention, it is possible to identify the resolution of an input video signal and display video, without having any restriction on the maximum resolution or on the identifiable type of resolution, employing a method and structure that generate various control signals corresponding to the input video signal and necessary for displaying video without using a special circuit that identifies the resolution of the input video signal.

### BRIEF DESCRIPTIONS OF THE DRAWINGS

FIG. 1 is a block diagram showing a schematic configuration of an active-matrix liquid crystal display device shown as an example of the present invention.

FIG. 2 is a drawing showing a configuration example of a circuit that receives a DE signal and a CLK signal and that generates an HRST_start signal and an HRST_end signal.

FIG. 3 is a timing chart for explaining a mode of operation of the circuit in FIG. 2.

FIG. 4 is a drawing showing a configuration example of a circuit that generates an L-ISP signal using the URST_start signal as a reference.

FIG. 5 is a drawing showing a configuration example of a circuit that generates an STB signal, a POL signal, a VCK signal, and a VOE signal using the HRST_end signal as a reference.

FIG. 6 is a timing chart for explaining a mode of operation of the circuit in FIG. 5.

FIG. 7 is a drawing showing a configuration example of a circuit that generates a VALID signal using the HRST_start signal and the HRST_end signal.

FIG. 8 is a drawing showing a configuration example of a circuit that generates a VSP signal using the VALID signal generated by the circuit in FIG. 7.

FIG. 9 is a timing chart for explaining a mode of operation of the circuits in FIGS. 7 and 8.

### PREFERRED MODES

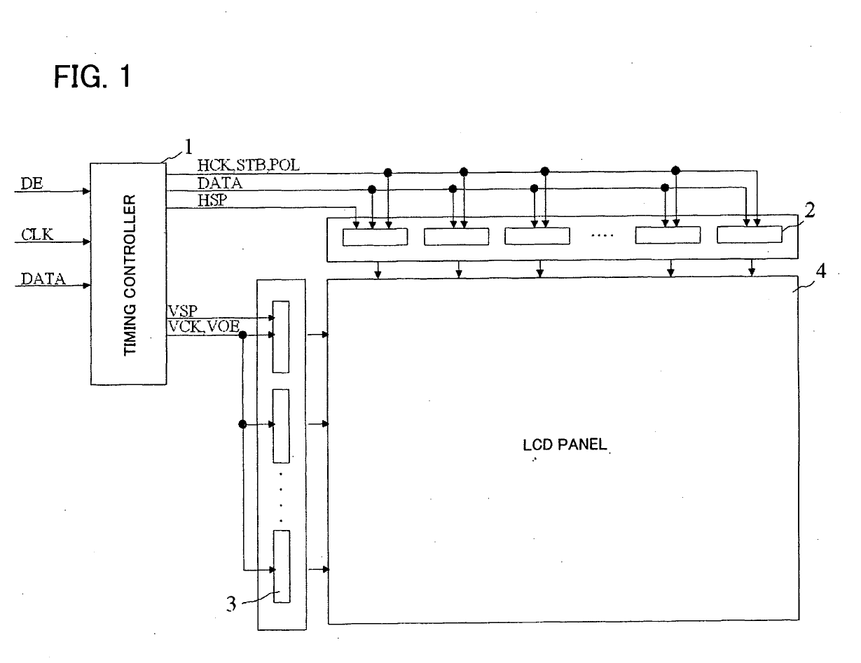

Next, preferred modes for carrying out the present invention will be described in detail with reference to the drawings. FIG. 1 is a block diagram showing a schematic configuration of an active-matrix liquid crystal display device shown as an example of the present invention.

In FIG. 1, the liquid crystal display device including a timing controller 1, a plurality of source drivers 2 disposed horizontally, a plurality of gate drivers 3 disposed vertically, and an LCD panel 4 is shown.

The timing controller 1 processes video data and a timing signal so as to drive the source drivers 2 and the gate drivers 3 and transmits data and various control signals to the source drivers 2 and the gate drivers 3.

More concretely, the timing controller 1 receives a DE (data enable) signal, a CLK (dot clock) signal, and DATA (video display data) as input signals. Based on these input signals, the timing controller 1 outputs a source driver start pulse (HSP), a data latch pulse (STB), a polarity inversion signal (POL), and a source driver shift clock (HCK) signal for controlling the source drivers 2.

Similarly, the timing controller 1 outputs a gate driver start pulse (VSP), a gate driver shift clock (VCK), and a gate driver output enable (VOE) signal for controlling the gate drivers 3 to the gate drivers 3.

Having received these control signals, the source drivers 2 and the gate drivers 3 transmit the data required to display video to each pixel of the liquid crystal panel and display the video. More concretely, the source drivers 2 convert the data received from the timing controller 1 and output a video data voltage required to drive the LCD panel 4. The gate drivers 3 output a control signal for turning on/off a TFT (not shown in the drawing) of the LCD panel 4.

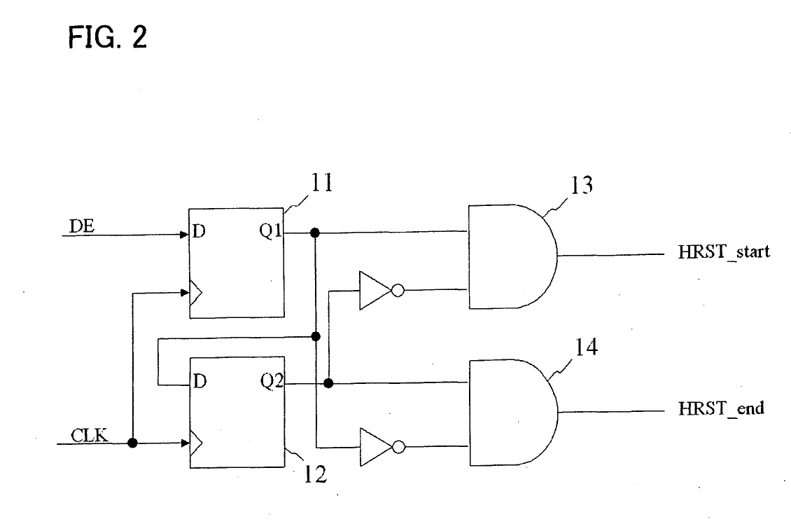

FIG. 2 is a drawing showing a configuration example of a circuit, in the timing controller 1, that receives the aforementioned DE signal and CLK signal and that generates an HRST_start signal and an HRST_end signal, which become a reference when each control signal described later is generated. Referring to FIG. 2, this circuit is formulated by two D-type flip-flops (D-FF) 11 and 12 and two AND circuits 13 and 14.

The DE signal line is connected to a DATA input terminal of the first D-FF11 and the CLK signal line is connected to each CLK input terminal of the first and second D-FFs 11 and 12. A DATA input terminal of the second D-FF12 is connected to an output terminal Q1 of the first D-FF11.

The first AND circuit 13 receives a signal from the output terminal Q1 of the first D-FF11 and an inverted signal of the output terminal Q2 of the second D-FF12. The second AND circuit 14 receives an inverted signal of the output terminal Q1 of the first D-FF11 and a signal from the output terminal Q2 of the second D-FF12.

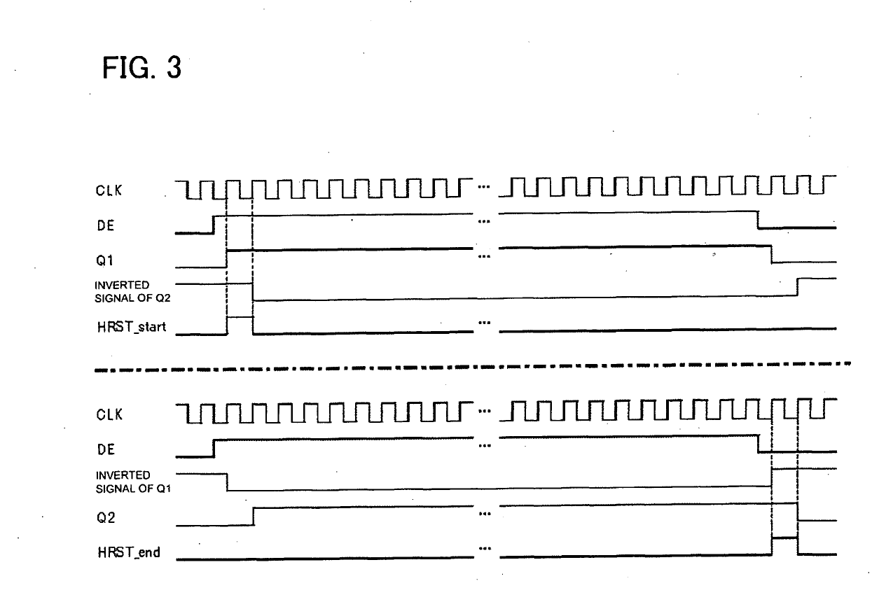

Using a timing chart in FIG. 3, how the circuit in FIG. 2 generates the HRST_start signal and the HRST_end signal will be described. First, the first D-FF11 outputs the DE signal in synchronization with the CLK signal. The second D-FF12 outputs the DE signal one clock period after the output of the first D-FF11. The AND circuit 13 outputs the HRST_start signal by performing an AND operation on the output Q1 of the D-FF11 and the inverted signal of the output Q2 of the D-FF12 (refer to the section indicated by broken lines on the upper left part in FIG. 3).

Meanwhile, after the DE signal has been received, the first D-FF11 ends the output of the DE signal in synchronization with the CLK signal. The second D-FF12 ends the output of the DE signal one clock period after the output of the first D-FF11. The AND circuit 14 outputs the HRST_end signal by performing an AND operation on the inverted signal of the output Q11 of the D-FF11 and the output Q2 of the D-FF12 (refer to the section of broken lines on the lower right part in FIG. 3).

Next, a method in which the HSP signal, the STB signal, the POL signal, the VCK signal, and the VOE signal are generated using the HRST_start signal and the HRST_end signal will be described.

First, an explanation will be made regarding the HSP signal transmitted to the source drivers 2. The HSP signal must be generated “A”-clock period before the first DATA defined by the source driver input standards. Therefore, using the HRST_start signal as a reference, the HSP signal is generated at a timing earlier than an internal delay α, occurring in the timing controller 1 during data processing, by A-clock period.

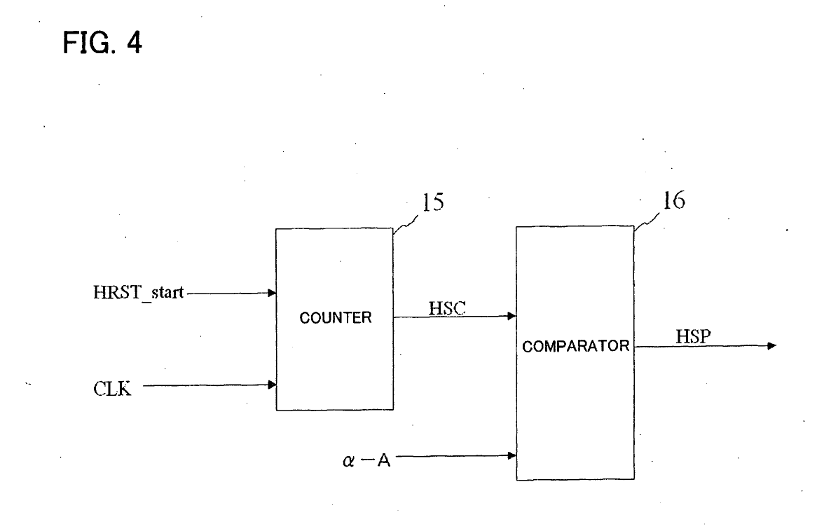

FIG. 4 is a drawing showing a configuration example of a circuit, in the timing controller 1, that generates the HSP signal using the HRST_start signal as a reference. Referring to FIG. 4, this circuit is formulated by a counter 15 and a comparator 16.

The counter 15 receives the HRST_start signal and the CLK signal. The counter 15 operates using the HRST_start signal as a Reset and Start signal and outputs a count value (HSC) using the CLK signal as a counter signal.

The comparator 16 receives a value (α−A) obtained by subtracting “A”-clock period from the internal delay clock α, which is the timing of the HSP signal, and the value of the counter 15 (HSC), compares the value of HSC with (α−A), and generates the HSP signal when an equation HSC=α−A becomes valid.

Next, an explanation will be made regarding the other control signals (the STB signal, the POL signal, the VCK signal, and the VOE signal) transmitted to the source drivers 2. The STB signal must be generated “B”-clock period after the last DATA defined by the source driver input standards. Therefore, using the HRST_end signal as a reference, the STB signal is generated at a timing later than the internal delay α, occurring in the controller during data processing, by the predetermined clock period B.

The POL signal is switched at a timing later than the rising of the STH signal by a predetermined clock period C in order to satisfy Setup/Hold Time for the rising of the STB signal defined by the source driver input standards.

The VCK signal and the VOE signal are generated at a timing earlier than the rising of the STB signal by a predetermined clock period D, taking a signal delay caused by the wiring load of gate electrodes of the liquid crystal panel into consideration.

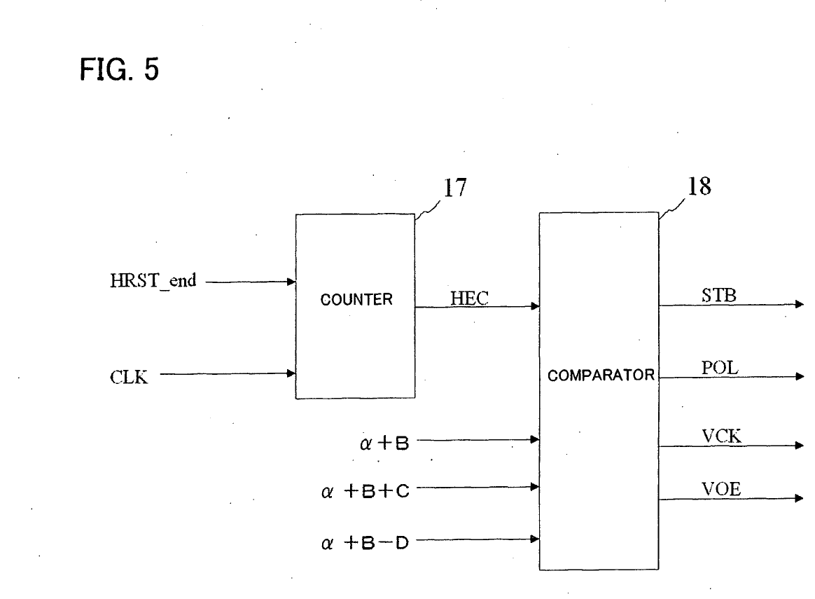

FIG. 5 is a drawing showing a configuration example of a circuit, in the timing controller 1, that generates the STB signal, the POL signal, the VCK signal, and the VOE signal using the HRST_end signal as a reference. Referring to FIG. 5, this circuit is formulated by a counter 17 and a comparator 18.

The counter 17 receives the HRST_end signal and the CLK signal. The counter 17 operates using the HRST_end signal as a Reset and Start signal and outputs a count value (HEC) using the CLK signal as a counter signal.

The comparator 18 receives the value of (α+B), which is the generation timing of the STB signal, the value of (α+B+C), which is the generation timing of the POL signal, the value of (α+B−D), which is the generation timing of the VCK and VOE signals, and the value of the counter 17 (HEC). The comparator 18 generates the STB signal when an equation HEC=α+B becomes valid.

Similarly, the counter 18 generates the POL signal when an equation HEC=α+B+C becomes valid. Further, the counter 18 generates the VCK and VOE signals when an equation HEC=α+B−D becomes valid.

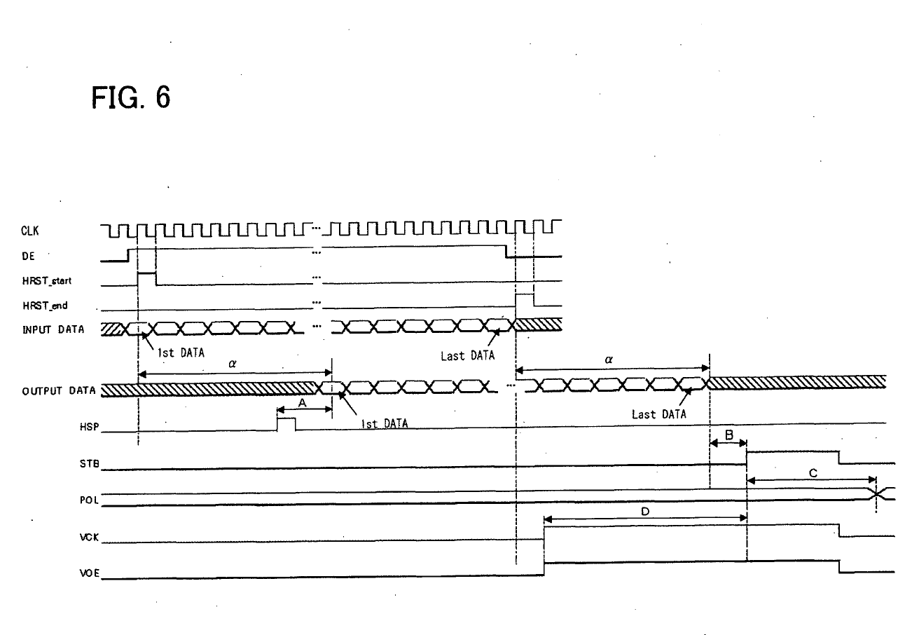

FIG. 6 shows the generation timing of each control signal: the HSP signal, the STB signal, the POL signal, the VCK signal, and the VOE signal, with the HRST_start signal and the HRST_end signal as references.

Referring to FIG. 6, the HSP signal is outputted at a timing later than the HRST_start signal by (α−A) clock period. Similarly, the STB signal, the POL signal, and the VCK and VOE signals are outputted at timings later than the HRST_end signal by (α+B) clock, (α+B+C) clock, and (α+B−D) clock periods, respectively.

Next, an explanation will be made regarding the VSP signal transmitted to the gate drivers 3. Since the VSP signal is a gate driver start pulse, it must be generated at the first frame (the first line) of the video input signal. First, we consider a method that generates a VALID signal indicating a vertical active period and generates the VSP signal from the VALID signal.

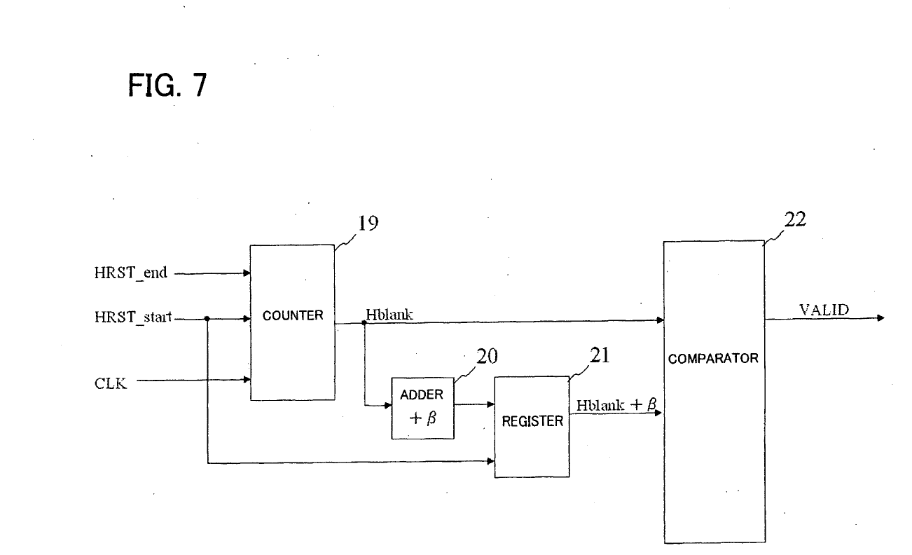

FIG. 7 is a drawing showing a configuration example of a circuit, in the timing controller 1, that generates the VALID signal for the VSP signal using the HRST_start signal and the HRST_end signal as references. Referring to FIG. 7, this circuit is formulated by a counter 19, an adder 20, a register 21, and a comparator 22.

The counter 19 receives the HRST_start signal, the HRST_end signal, and the CLK signal. The counter 19 operates using the HRST_end signal as a Reset and Start signal, starts counting using the CLK signal as a counter signal, stops counting when it receives the HRST_start signal, and outputs a count value (Hblank).

The adder 20 outputs a value obtained by adding a predetermined clock β to the count value (Hblank) outputted by the counter 19 to the register 21. It should be noted that the value of β is determined taking a case where the blanking period of a horizontal period of the video input signal fluctuates into consideration.

The register 21 receives the HRST_start signal and the value (Hblank+β) outputted from the adder 20. The register 21 stores the value of (Hblank+β) at a timing when it receives the HRST_start signal.

The comparator 22 compares the output (Hblank) of the counter 19 with the output (Hblank+β) of the register 21 and generates the VALID signal that goes to a high level when the output (Hblank+β) of the register 21 is larger than the output (Hblank) of the counter 19 and that goes to a low level when the output (Hblank+β) of the register 21 is smaller than the output (Hblank) of the counter 19.

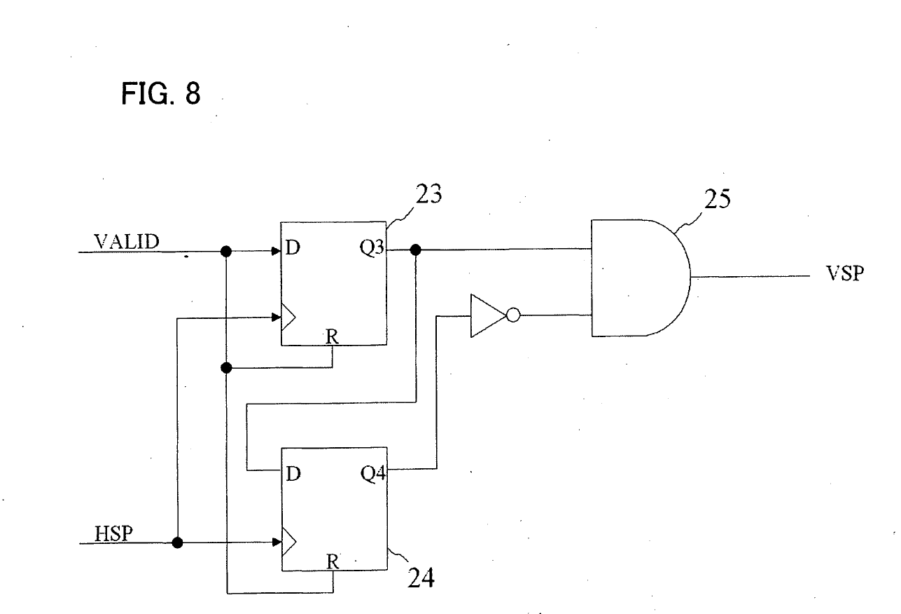

FIG. 8 is a drawing showing a configuration example of a circuit, in the timing controller 1, that generates the VSP signal using the VALID signal as a reference. Referring to FIG. 8, this circuit is constituted by two D-FFs 23 and 24, and an AND circuit 25.

D-FF23 outputs the VALID signal in synchronization with the HSP signal. D-FF24 outputs an inverted signal of the VALID signal at a timing later than the output of D-FF23 by a period corresponding to one HSP signal. The AND circuit 25 generates the VSP signal by performing an AND operation on an output Q3 of D-FF23 and the inverted signal of an output Q4 of D-FF24. Further, when the VALID signal goes to a low level, D-FFs 23 and 24 are reset.

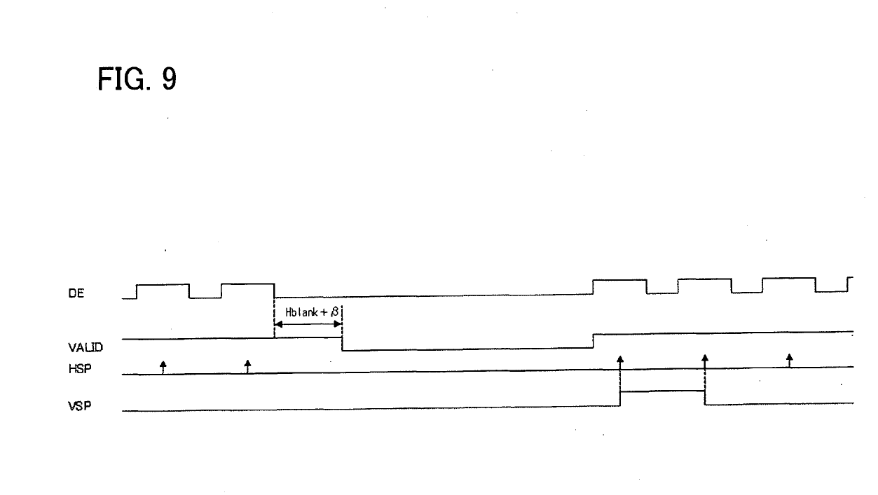

As a result, as shown in FIG. 9, the VSP signal that becomes active when the first HSP signal rises after the VALID signal has risen and that remains active until the next HSP signal is generated.

When a display device needs to deal with various resolution signals, the active period during which the device receives a horizontal signal varies as well, however, according to the timing controller 1 that operates as described above, it becomes possible to generate each control signal necessary for displaying video without any regard to the active period and transmit these control signals to each driver of the video display device as soon as the active period ends. In other words, the driver control signals can be generated without any regard to the resolution or the type of resolution of the input video signal.

The reason is that the method that generates the horizontal reference signal (HRST_start) and the other horizontal reference signal (HRST_end) detecting the start and end of the active period of the DE signal in the timing control during which the control signals necessary for displaying video on the video display device are generated from the input video signal and that generates each video control signal using the horizontal reference signals as references is employed.

Further, as evident from the example described above, according to the present invention, a special circuit that identifies the resolution of the input video signal is not necessary. Further, since the special circuit that identifies the resolution of the input video signal is not provided, there is no restriction on the maximum identifiable resolution and on the identifiable type of resolution.

The entire disclosures of the aforementioned Patent Documents are incorporated herein by reference thereto.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

For instance, the present invention may be realized using circuits equivalent to the example described above. Further, the present invention can be applied not only to the example described above (liquid crystal display), but also to various types of video display devices such as other types of liquid crystal display and PDP (Plasma Display Panel).

What is claimed is:

1. A video processing method comprising:
having a timing controller of a video display device generate a first horizontal reference signal indicating the start of an active period of a data enable signal and a second horizontal reference signal indicating the end of said active period from an input video signal; and
having the timing controller of said video display device generate control signals based on the number of clocks from the rise of said first and second horizontal reference signals and on signal generation timing value determined for each of said control signals supplied to drivers.

2. The video processing method as defined in claim 1, wherein the timing controller of said video display device generates a horizontal start-pulse signal based on the number of clocks from the rise of said first horizontal reference signal and on signal generation timing value determined for said horizontal start-pulse signal.

3. The video processing method as defined in claim 2, wherein the timing controller of said video display device generates a vertical start-pulse signal that becomes active when a first horizontal start-pulse signal rises after a predetermined blanking period has lapsed and that remains so until a next horizontal start-pulse signal.

4. The video processing method as defined in claim 1 wherein the timing controller of said video display device generates a data latch pulse STB, a polarity inversion signal POL, a gate driver shift clock VCK, and a gate driver output enable signal VOE based on the number of clocks from the rise of said second horizontal reference signal and on signal generation timing value determined for each of said control signals.

5. The video processing method as defined in claim 2, wherein a signal generation timing value for said horizontal start-pulse signal is a timing obtained by subtracting a predetermined number of clocks from a time obtained by adding an internal delay clock to the rise time of said first horizontal reference signal.

6. The video processing method as defined in claim 4, wherein a signal generation timing value for said data latch pulse STB is a timing obtained by subtracting a predetermined number of clocks from a time obtained by adding an internal delay clock to the rise time of said second horizontal reference signal.

7. The video processing method as defined in claim 6, wherein a signal generation timing value for said polarity inversion signal POL is a timing obtained by adding a predetermined number of clocks to the rise time of said data latch pulse STB.

8. The video processing method as defined in claim 6, wherein a signal generation timing value for said gate driver shift clock VCK and gate driver output enable signal VOE is a timing obtained by subtracting a predetermined number of clocks from the rise time of said data latch pulse STB.

9. A timing controller of a video display device comprising:
a horizontal reference signal generating circuit that generates a first horizontal reference signal indicating the start of an active period of a data enable signal and a second horizontal reference signal indicating the end of said active period from an input video signal; and
a control signal generating circuit that generates control signals based on the number of clocks from the rise of said first and second horizontal reference signals and on signal generation timing value determined for each of said control signals supplied to drivers.

10. The timing controller of a video display device as defined in claim 9, wherein said control signal generating circuit generates a horizontal start-pulse signal based on the number of clocks from the rise of said first horizontal reference signal and on signal generation timing value determined for said horizontal start-pulse signal.

11. The timing controller of a video display device as defined in claim 10, wherein said control signal generating circuit generates a vertical start-pulse signal that becomes active when a first horizontal start-pulse signal rises after a predetermined blanking period has lapsed and that remains so until a next horizontal start-pulse signal.

12. The timing controller of a video display device as defined in claim 9, wherein said control signal generating circuit generates a data latch pulse STB, a polarity inversion signal POL, a gate driver shift clock VCK, and a gate driver output enable signal VOE based on the number of clocks from the rise of said second horizontal reference signal and on signal generation timing value determined for each of said control signals.

13. The timing controller of a video display device as defined in claim 12, wherein a signal generation timing value for said horizontal start-pulse signal is a timing obtained by subtracting a predetermined number of clocks from a time obtained by adding an internal delay clock to the rise time of said first horizontal reference signal.

14. The timing controller of a video display device as defined in claim 13, wherein a signal generation timing value for said data latch pulse STB is a timing obtained by subtracting a predetermined number of clocks from a time obtained by adding an internal delay clock to the rise time of said second horizontal reference signal.

15. The timing controller of a video display device as defined in claim 14, wherein a signal generation timing value for said polarity inversion signal POL is a timing obtained by adding a predetermined number of clocks to the rise time of said data latch pulse STB.

16. The timing controller of a video display device as defined in claim 14, wherein a signal generation timing value for said gate driver shift clock VCK and gate driver output enable signal VOE is a timing obtained by subtracting a predetermined number of clocks from the rise time of said data latch pulse STB.

17. A video display device comprising the timing controller as defined in claim 9.
